(19) United States
(12) Patent Application Publication
(10) Pub. No.: US 2026/0042405 A1
(43) Pub. Date: Feb. 12, 2026

(54) OCCUPANT IMAGING APPARATUS AND METHOD OF MANUFACTURING OCCUPANT IMAGING APPARATUS

(71) Applicant: MITSUBISHI ELECTRIC MOBILITY CORPORATION, Tokyo (JP)

(72) Inventor: Hideyuki HIROTA, Tokyo (JP)

(73) Assignee: MITSUBISHI ELECTRIC MOBILITY CORPORATION, Tokyo (JP)

(21) Appl. No.: 19/099,616

(22) PCT Filed: Oct. 21, 2022
(86) PCT No.: PCT/JP2022/039226

§ 371 Date: Jan. 29, 2025

(51) Int. Cl. B60R 11/04

(52) U.S. Cl. CPC B60R 11/04

(57) ABSTRACT

An object is to provide a technology that can suppress the size of an occupant imaging apparatus that images an occupant of a vehicle. The occupant imaging apparatus includes a board, an imager, and a plurality of light emitters. The imager is disposed on the board. The imager images at least one occupant on a driver seat, a passenger's seat, or a rear seat of the vehicle. The plurality of light emitters are disposed on the board. The plurality of light emitters emit light to be directed to the at least one occupant on the driver seat, the passenger's seat, or the rear seat of the vehicle. The plurality of light emitters are located on one side of the imager in a vehicle-width direction of the vehicle.

### BACKGROUND OF THE INVENTION

### Field of the Invention

The present disclosure relates to an occupant imaging apparatus and a method of manufacturing the occupant imaging apparatus.

### Description of the Background Art

Various technologies on occupant imaging apparatuses each of which images an occupant of a vehicle have been proposed. For example, Patent Document 1 proposes a configuration including light emitters on both sides of an imager.

### PRIOR ART DOCUMENT

### Patent Document

Patent Document 1: Japanese Patent Application Laid-Open No. 2019-202726

### SUMMARY

### Problem to be Solved by the Invention

The configuration including the light emitters on both sides of the imager has, however, a problem of an increase in the size of an occupant imaging apparatus because a light proof enclosure needs walls to prevent light from the left and right light emitters from directly entering the imager.

The present disclosure has been made in view of the problem, and has an object of providing a technology that can suppress the size of an occupant imaging apparatus.

### Means to Solve the Problem

An occupant imaging apparatus according to the present disclosure includes: a board; an imager disposed on the board to image at least one occupant on a driver seat, a passenger's seat, or a rear seat of a vehicle; and a plurality of light emitters disposed on the board to emit light to be directed to the at least one occupant, wherein the plurality of light emitters are located on one side of the imager in a vehicle-width direction of the vehicle.

### EFFECTS OF THE INVENTION

The present disclosure can suppress the size of an occupant imaging apparatus.

The object, features, aspects, and advantages of the present disclosure will become more apparent from the following detailed description and the accompanying drawings.

### BRIEF DESCRIPTION OF THE DRAWINGS

FIG. 1 is a plan view of a configuration of an occupant imaging apparatus according to Embodiment 1.

FIG. 2 is a cross-sectional view of the configuration of the occupant imaging apparatus according to Embodiment 1.

FIG. 3 is a plan view of a configuration of a relevant device.

FIG. 4 is a cross-sectional view of the configuration of the relevant device.

FIG. 5 is a cross-sectional view illustrating a method of manufacturing the occupant imaging apparatus according to Embodiment 1.

FIG. 6 is a plan view illustrating a configuration of an occupant imaging apparatus according to modification 1.

FIG. 7 is a plan view illustrating placement of an occupant imaging apparatus according to Modification 2.

FIG. 8 is a plan view illustrating placement of the occupant imaging apparatus according to Modification 2.

FIG. 9 is a plan view illustrating placement of an occupant imaging apparatus according to Modification 3.

### DESCRIPTION OF THE PREFERRED EMBODIMENTS

### Embodiment 1

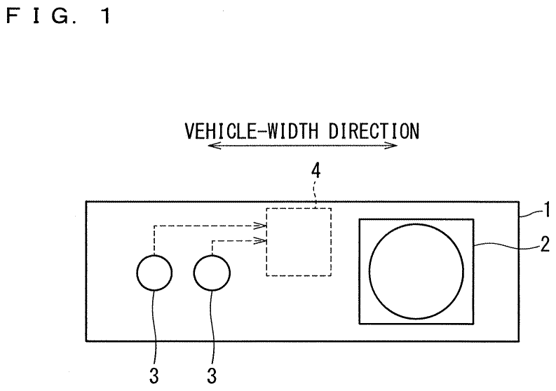

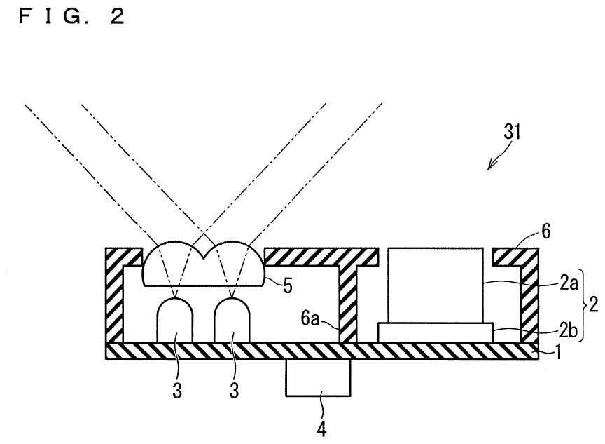

FIG. 1 and FIG. 2 are a plan view and a cross-sectional view, respectively, of a configuration of an occupant imaging apparatus 31 according to Embodiment 1. FIG. 1 omits the illustration of a part of the configuration of the occupant imaging apparatus 31 for convenience.

As illustrated in FIGS. 1 and 2, the occupant imaging apparatus 31 according to Embodiment 1 includes a board 1, an imager 2, a plurality of light emitters 3, a power circuit 4, lenses 5 that are light guides, and a light proof enclosure 6.

Although the board 1 is rectangular, the shape of the board 1 is not limited to the rectangle. The board 1 is, for example, an insulating board with a wiring pattern. The imager 2, the plurality of light emitters 3, and the light proof enclosure 6 are disposed on the upper surface of the board 1, and the power circuit 4 including a collector is disposed on the lower surface of the board 1.

The imager 2 images at least one occupant on a driver seat, a passenger's seat, or a rear seat of a vehicle. The imager 2 includes a camera lens 2a and an image sensor 2b. The image sensor 2b generates an image based on the light incident on the camera lens 2a.

The plurality of light emitters 3 are, for example, light-emitting diodes (LEDs), and emit light to be directed to the occupant. As illustrated in FIG. 1, the plurality of light emitters 3 are located on one side (on the left end in FIG. 1) of the imager 2 in a vehicle-width direction of the vehicle.

The power circuit 4 is electrically connected to the imager 2 and the plurality of light emitters 3, and supplies power to the imager 2 and the plurality of light emitters 3. In Embodiment 1, the power circuit 4 is located on the same side (on the left in FIG. 1) as the plurality of light emitters 3 with respect to the imager 2 in a plan view of the board 1, that is, when a plane of the board 1 is viewed from the front.

Although the plurality of light emitters 3 are arranged in a lateral direction in the example of FIG. 1, the direction is not limited to this but the plurality of light emitters 3 may be arranged in a longitudinal direction. Furthermore, the plurality of light emitters 3 may be disposed on one side of the power circuit 4, on both sides of the power circuit 4, or around the power circuit 4 in a plan view of the board 1.

The lenses 5 of FIG. 2 direct the light from the plurality of light emitters 3 to the occupant to be imaged by the imager 2. The light proof enclosure 6 covers the imager 2 and the plurality of light emitters 3, except an opening in which the camera lens 2a fits and an opening in which the lenses 5 fit. In the example of FIG. 2, the light proof enclosure 6 includes one wall 6a that is disposed between the imager 2 and the plurality of light emitters 3, and prevents the light from the plurality of light emitters 3 from directly entering the imager 2.

The aforementioned occupant imaging apparatus 31 can generate an image of a certain brightness by appropriately adjusting the light from the light emitters 3 according to ambient light. Since a configuration in which the light emitters 3 emit infrared light can prevent the light from influencing a person's view, the configuration is applicable to, for example, a Driver Monitoring System (DMS) that monitors a state of a driver in a vehicle.

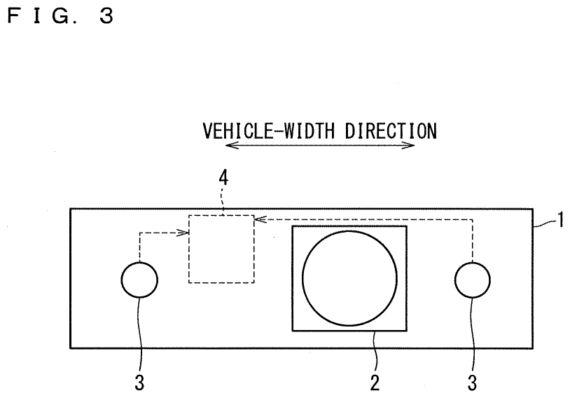

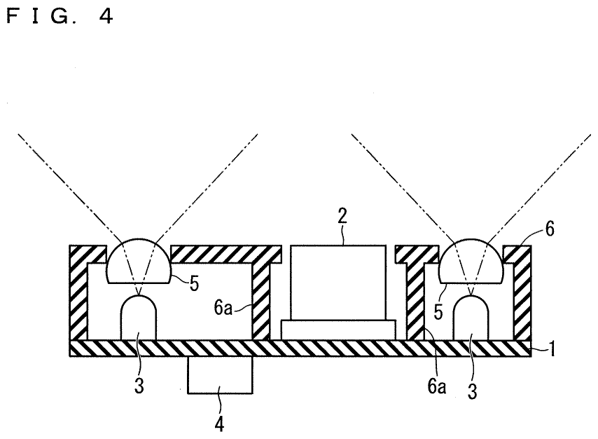

Next, a relevant device relevant to the occupant imaging apparatus 31 according to Embodiment 1 will be described. FIG. 3 and FIG. 4 are a plan view and a cross-sectional view of a configuration of the relevant device, similarly to FIG. 1 and FIG. 2, respectively. In the relevant device, one light emitter 3 is located on one side of the imager 2 in a vehicle-width direction, and another light emitter 3 is located on the other side of the imager 2 in the vehicle-width direction. In other words, the plurality of light emitters 3 are not located on one side of the imager 2 in the vehicle-width direction.

In such a configuration, the light proof enclosure 6 needs to include not the one wall 6a but two walls 6a as illustrated in FIG. 4 to prevent the light from the plurality of light emitters 3 from directly entering the imager 2. Furthermore, although the power circuit 4 is located on the same side as the one light emitter 3 with respect to the imager 2, the power circuit 4 is located on the opposite side of the other light emitter 3 with respect to the imager 2. As indicated by dashed arrows in FIG. 3, a wiring pattern of the light emitters 3 is complicated.

In contrast, the plurality of light emitters 3 are located on one side of the imager 2 in the vehicle-width direction in the occupant imaging apparatus 31 according to Embodiment 1. Since this configuration can reduce the number of the walls 6a of the light proof enclosure 6 as illustrated in FIG. 2, for example, the length of the board 1 in the longer direction can be suppressed and the size of the occupant imaging apparatus 31 can be suppressed.

In Embodiment 1, the power circuit 4 is located on the same side as the plurality of light emitters 3 with respect to the imager 2 in a plan view of the board 1. Such a configuration can simplify a wiring pattern of the light emitters 3 as indicated by dashed arrows in FIG. 1. Consequently, for example, facilitating installation of additional light emitters 3 can be expected.

Next, a method of manufacturing the occupant imaging apparatus 31 according to Embodiment 1 will be described. First, a structure obtained by excluding the lenses 5 from the occupant imaging apparatus 31, and a plurality of lenses 5 are prepared. The structure should include, for example, the board 1, the imager 2, and the plurality of light emitters 3 that are described in Embodiment 1, and need not include the light proof enclosure 6. The plurality of lenses 5 with different shapes differ in at least one of an directing angle or an directing distance.

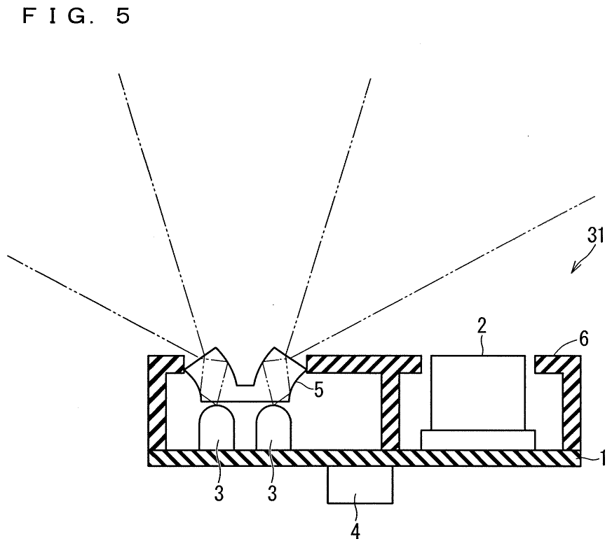

After the structure and the plurality of lenses 5 are prepared, one of the plurality of lenses 5 is attached to the structure to direct the light emitted from the plurality of light emitters 3 to the occupant. FIG. 5 illustrates the occupant imaging apparatus 31 equipped with the lenses 5 with directing angles and directing distances that are different from those of the lenses 5 in FIG. 2.

In such a configuration, selecting one of the lenses 5 to be attached to the structure while sharing the structure can easily change at least one of the directing angle or the directing distance of the occupant imaging apparatus 31.

### Modification 1

When the plurality of light emitters 3 include a first light emitter and a second light emitter, the lenses 5 may direct light from the first light emitter and light from the second light emitter in the same direction. Such a configuration can increase the intensity of the light to be directed to the occupant.

Furthermore, when the plurality of light emitters 3 include the first light emitter and the second light emitter, the lenses 5 may direct the light from the first light emitter and the light from the second light emitter in different directions. Since such a configuration can direct light to a plurality of ranges, for example, the light can be directed to a plurality of occupants or to a plurality of portions of one occupant.

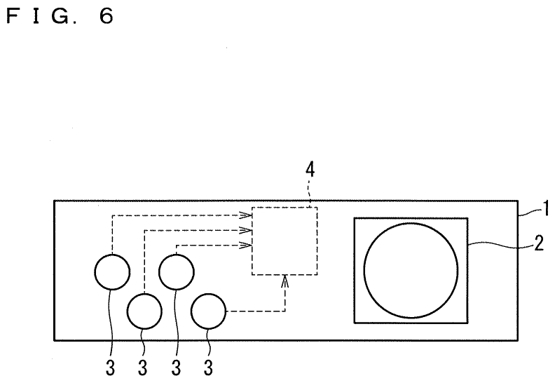

Although the number of the light emitters 3 is two in the aforementioned description, the number is not limited to this but may be three, four as illustrated in FIG. 6, or more. Such a configuration can further increase the intensity of light, further direct light to a plurality of ranges, or implement both of these.

### Modification 2

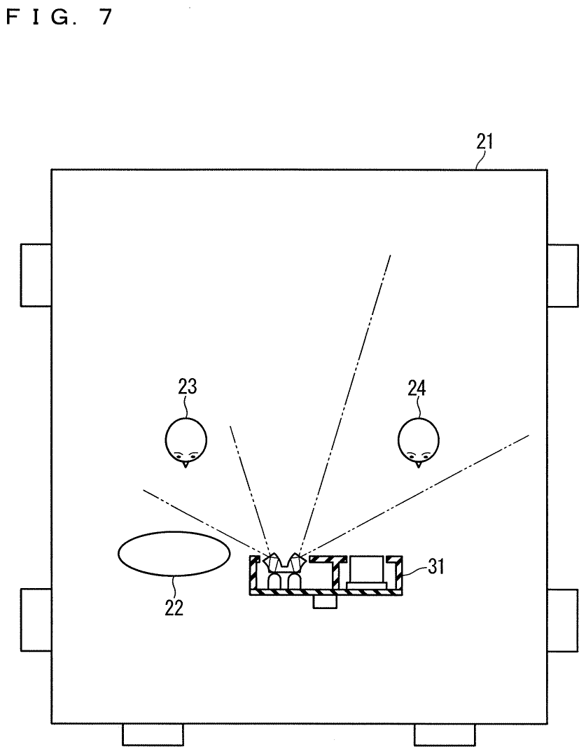

As illustrated in FIG. 7, the occupant imaging apparatus 31 may be disposed in a central portion of a front portion in a cabin of a vehicle 21. The central portion of the front portion in the cabin of the vehicle 21 includes, for example, a central portion of a dashboard of the vehicle 21, a peripheral portion of a rear-view mirror of the vehicle 21, and a central portion of a windshield of the vehicle 21. FIG. 7 illustrates a steering wheel 22 installed on a side of the driver seat.

When the plurality of light emitters 3 include the first light emitter and the second light emitter, the lenses 5 may direct the light from the first light emitter to a driver 23 that is an occupant on the driver's seat, and direct the light from the second light emitter to an occupant 24 on the passenger's seat. Such a configuration enables the single occupant imaging apparatus 31 to direct light to the driver 23 and the occupant 24 on the passenger's seat, and image the driver 23 and the occupant 24.

The lenses 5 may direct the light from the second light emitter to an occupant on the rear seat. When the plurality of light emitters 3 include a plurality of second light emitters, the lenses 5 may direct the light from one of the second light emitters to the occupant 24 on the passenger's seat and direct the light from the other one of the second light emitters to the occupant on the rear seat.

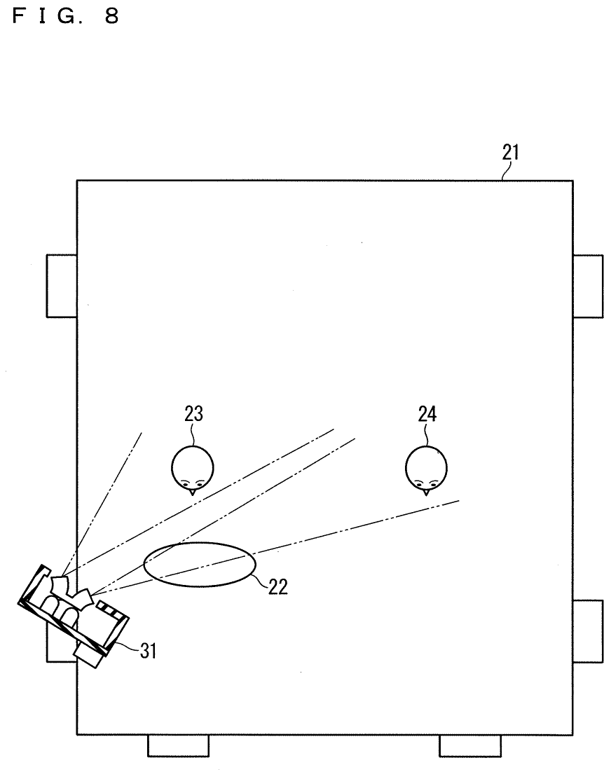

As illustrated in FIG. 8, the occupant imaging apparatus 31 may be disposed on a pillar on the side of the driver seat in the vehicle 21, with the longer direction of the board 1 being along an extension direction of the pillar. When the occupant imaging apparatus 31 is disposed on the pillar on the side of the driver seat, the plurality of light emitters 3 should be located on one side of the imager 2 in a plan view of the board 1, irrespective of the vehicle-width direction.

### Modification 3

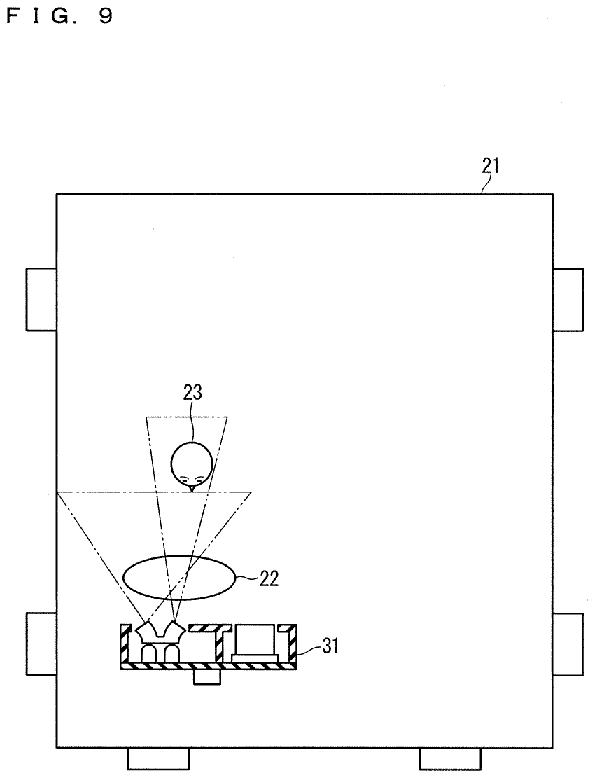

As illustrated in FIG. 9, the occupant imaging apparatus 31 disposed on, for example, a steering wheel column or a meter panel may be disposed to face the driver seat. When the plurality of light emitters 3 include the first light emitter and the second light emitter, the lenses 5 may direct the light from the first light emitter to the driver 23, and direct the light from the second light emitter to the driver 23 in a range that differs in directing angle and directing distance from the light from the first light emitter. Such a configuration can increase the intensity of the light to be directed to the driver 23, and image the driver 23 in a wide range.

The details of the embodiments can be appropriately modified and omitted.

The foregoing description is in all aspects illustrative and is not restrictive. It is understood that numerous modifications that have not yet been exemplified can be devised.

### EXPLANATION OF REFERENCE SIGNS

1 board, 2 imager, 3 light emitter, 4 power circuit, 5 lens, 21 vehicle, 23 driver, 24 occupant, 31 occupant imaging apparatus.

1. An occupant imaging apparatus, comprising:
a board;
an imager disposed on the board to image at least one occupant on a driver seat, a passenger's seat, or a rear seat of a vehicle;
a plurality of light emitters disposed on the board to emit light to be directed to the at least one occupant; and,
a light proof enclosure covering the imager and the plurality of light emitters, the light proof enclosure including a wall that prevents the light emitted from the plurality of light emitters from entering the imager,
wherein the plurality of light emitters are located on one side of the imager in a vehicle-width direction of the vehicle, and
the wall of the light proof enclosure is disposed between the imager and the plurality of light emitters.

2. The occupant imaging apparatus according to claim 1,
wherein the plurality of light emitters include a first light emitter and a second light emitter,
the occupant imaging apparatus, further comprising
a light guide to direct light from the first light emitter to the occupant on the driver seat, and direct light from the second light emitter to the occupant on the passenger's seat or the rear seat.

3. The occupant imaging apparatus according to claim 2,
wherein the occupant imaging apparatus is disposed in a central portion of a front portion in a cabin of the vehicle.

4. The occupant imaging apparatus according to claim 1,
wherein the occupant imaging apparatus is disposed to face the driver seat, and
the plurality of light emitters include a first light emitter and a second light emitter,
the occupant imaging apparatus, further comprising
a light guide to direct light from the first light emitter to the occupant on the driver seat, and direct light from the second light emitter to the occupant on the driver seat in a range that differs in directing angle and directing distance from the light from the first light emitter.

5. The occupant imaging apparatus according to claim 1,
wherein the plurality of light emitters include a first light emitter and a second light emitter,
the occupant imaging apparatus, further comprising
a light guide to direct light from the first light emitter and light from the second light emitter in a same direction.

6. The occupant imaging apparatus according to claim 1,
wherein the plurality of light emitters include a first light emitter and a second light emitter,
the occupant imaging apparatus, further comprising
a light guide to direct light from the first light emitter and light from the second light emitter in different directions.

7. The occupant imaging apparatus according to claim 1, further comprising
a power circuit disposed on the board, the power circuit being electrically connected to the plurality of light emitters,
wherein the power circuit is located on a same side as the plurality of light emitters with respect to the imager in a plan view of the board.

8. An occupant imaging apparatus, comprising:
a board;
an imager disposed on the board to image at least one occupant on a driver seat, a passenger's seat, or a rear seat of a vehicle;
a plurality of light emitters disposed on the board to emit light to be directed to the at least one occupant; and
a light proof enclosure covering the imager and the plurality of light emitters, the light proof enclosure including a wall that prevents the light emitted from the plurality of light emitters from entering the imager,
wherein the plurality of light emitters are located on one side of the imager in a plan view of the board,
the wall of the light proof enclosure is disposed between the imager and the plurality of light emitters, and
the occupant imaging apparatus is disposed on a pillar on a side of the driver seat in the vehicle.

9. A method of manufacturing an occupant imaging apparatus, the method comprising:
preparing a structure and a plurality of light guides that differ in at least one of an directing angle or an directing distance, the structure including: a board; an imager disposed on the board to image at least one occupant on a driver seat, a passenger's seat, or a rear seat of a vehicle; and a plurality of light emitters disposed on the board; and a light proof enclosure covering the imager and the plurality of light emitters, the light proof enclosure including a wall that prevents the light emitted from the plurality of light emitters from entering the imager, the plurality of light emitters being located on one side of the imager in a vehicle-width direction of the vehicle, the wall of the light proof enclosure being disposed between the imager and the plurality of light emitters; and
attaching one of the plurality of light guides to the structure to direct light emitted from the plurality of light emitters to the at least one occupant.
